(19) United States
(12) Patent Application Publication
(10) Pub. No.: US 2014/0054338 A1
(43) Pub. Date: Feb. 27, 2014

(54) Vacuum Mount System For Portable Electronic Device

(71) Applicant: Charles L. Casagrande, Bradenton, FL (US)

(72) Inventor: Charles L. Casagrande, Bradenton, FL (US)

(21) Appl. No.: 14/111,716

(22) PCT Filed: Apr. 16, 2012
(86) PCT No.: PCT/US12/33803

§ 371 Date: Oct. 14, 2013

Related U.S. Application Data
(60) Provisional application No. 61/475,501, filed on Apr. 14, 2011.

(51) Int. Cl. F16M 13/02; B65D 25/22

(52) U.S. Cl. CPC F16M 13/02; B65D 25/22
USPC 224/275; 248/542; 248/205.5; 206/577; 206/525

(57) ABSTRACT

A vacuum mount system a first vacuum device (12) configured for detachable connection to a portable electronic device (18), a second vacuum device (14) configured for detachable connection to a mounting surface (17), and a flexible connector (16) attached between the first vacuum device (12) and the second vacuum device (14).

### RELATED APPLICATIONS

This Non-Provisional application claims priority to United States Provisional Application Ser. No. 61/475,501 filed Apr. 14, 2011, and which is incorporated herein by reference.

### BACKGROUND ART

The present disclosure relates to a vacuum system that detachably secures portable electronic devices, such as, tablet computers, flat screens, and cell phones to various locations, including, but not limited to vehicle dash boards, windows, desks, table tops, walls, counter tops, airplane seat trays, and sunroofs.

Brackets are commonly used to hold electronics in conjunction with a suction cup device and connector, or ball and socket arm. However, conventional brackets are not universal and are bulky, unsightly, and difficult to attach or maintain holding strength. In short, they are complicated and have limitations. Typically, suction cups are used to attach to the substrate, but are notoriously untrustworthy in relation to holding strength and length of holding power. In addition, conventional suction cups eventually lose their suction power and the secured device falls off unexpectedly.

Generally, connectors are limited to use with lighter weight devices because they tend to drop or droop as a result of being mounted in a 90° position out from the center of the suction cup. Although ball and socket arms are stronger, they are very bulky and cannot be easily used on a car window or easily stowed or transported.

Therefore, a bracketless device is needed that provides a vacuum power indication and has a connector configured for easy attachment and detachment in a variety of applications and angles.

### BRIEF DESCRIPTION OF THE DRAWINGS

In the accompanying drawings which form part of the specification:

FIG. 1 is a perspective view of a prior art mount with an attached PED;

FIG. 2 is a perspective view of the prior art mount of FIG. 1 without the PED;

FIG. 3 is a perspective view of a vacuum mount system partially disassembled;

FIG. 4 is a perspective view of a vacuum device;

FIG. 5 is a perspective view of a vacuum pad;

FIG. 6 is a perspective view of a vacuum pump;

FIG. 7 is a perspective view of a housing;

FIG. 8 is a perspective view of a connector with end connectors;

FIG. 9 is a top view of a first alternate embodiment of the vacuum mount system;

FIG. 10 is a side view of a second alternate embodiment of the vacuum mount system;

FIG. 11 is a rear view of the second alternate embodiment of the vacuum mount system connected to a PED;

FIG. 12 is a front view of a third alternate embodiment of the vacuum mount system connected to a PED;

FIG. 13 is a side view of the third alternate embodiment of the vacuum mount system connected to a PED;

FIG. 14 is a perspective view of a fourth alternate embodiment of the vacuum mount system connected to a PED and a car windshield;

FIG. 15 is another perspective view of the fourth alternate embodiment of the vacuum mount system connected to a PED and a car windshield;

FIG. 16 is a perspective view of a fifth alternate embodiment of the vacuum mount system;

FIG. 17 is a perspective view of a partially dissembled vacuum mount system with a travel case;

FIG. 18 is a perspective view of a sixth alternate embodiment of a vacuum mount system with a keyboard attachment;

FIG. 19 is a side view of a seventh alternate embodiment of the vacuum mount system with the keyboard attachment;

FIG. 20 is a front view of an eighth alternate embodiment of the vacuum mount system with waterproof a PED;

FIG. 21 is a rear perspective view of the eighth alternate embodiment of the vacuum mount system with the waterproof PED;

FIG. 22 is a perspective view of a ninth alternate embodiment of the vacuum mount system attached to a vehicle headrest; and

FIG. 23 is a perspective view of a tenth alternate embodiment of the vacuum mount system attached to a vehicle headrest.

Corresponding reference numerals indicate corresponding parts throughout the several figures of the drawings.

### BEST MODE FOR CARRYING OUT THE INVENTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

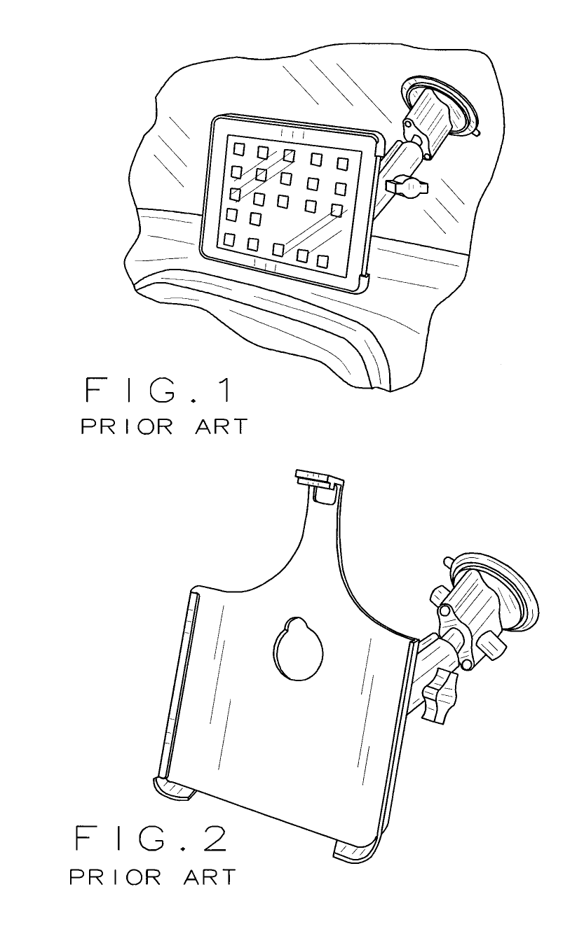

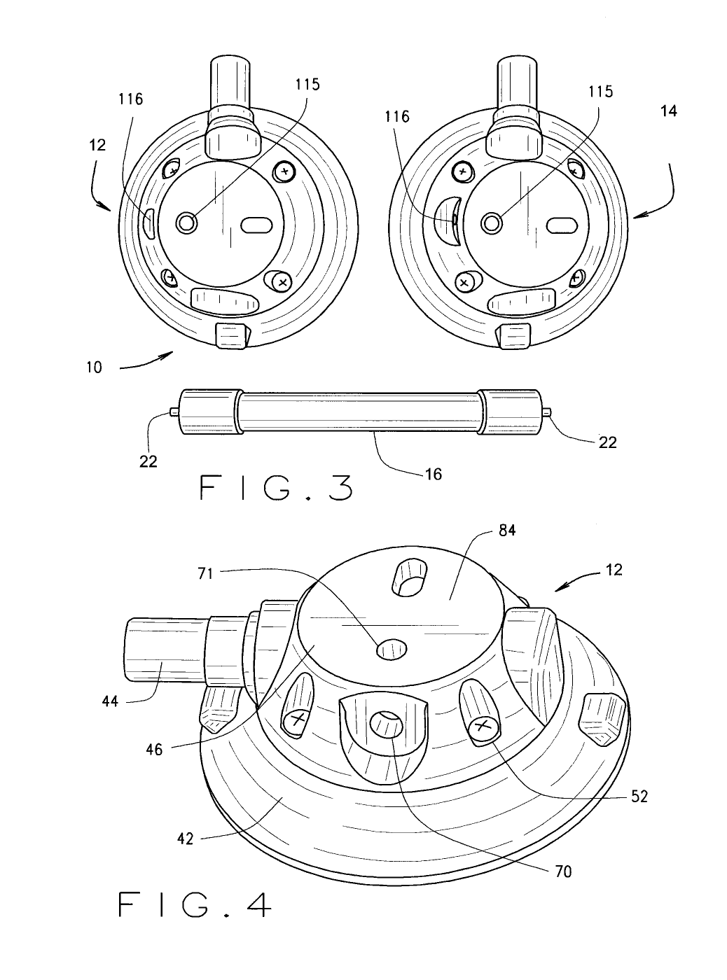

As shown in FIGS. 1-2, a prior art version of a mount system include bulky brackets, ball and socket arms, and suction cups. In order to hold heavier items like some Global Positioning Satellite (GPS) systems and PEDs, such as iPads®, the ball and socket arrangement has been used for its stability. Mount systems for lighter weight items have used connectors, but have not been successful with heavier items because the increased weight causes the item to fall or droop. This is largely because an arm has to extend outwardly and down from the suction cup, and then extend back up to the bracket. As shown in FIG. 3, the embodiment of the present disclosure, generally referred to as a vacuum mount system 10, includes a pair of vacuum devices 12 and 14 joined by a connector 16, which is configured for securement between a portable electronic device 18 (hereafter referred to as “PED”) and a mounting surface 20. A PED 18 includes, but is not limited to, tablet devices, mobile phones, laptop computers, global positioning systems, personal digital assistant, iPad®, iphone®, or other similar devices.

The connector 16 is a flexible arm having a fastener 22 at each end, preferably a ¼-20 male insert, however, other fasteners can also be used. For example, a magnetic fastener can be used. The connector 16 is preferably made of steel and is encased in plastic, such as those readily available in the marketplace. However, any suitable flexible support arm can be used. The fasteners 22 attach to respective vacuum devices 12 and 14 with corresponding fasteners 24, such as with ¼-20 female inserts.

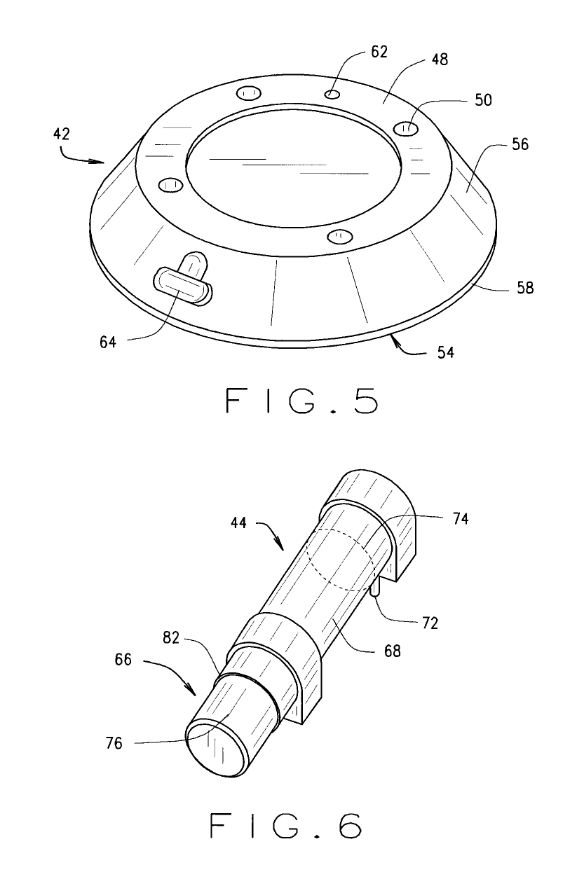

The vacuum device 12 and 14 are similar to the device disclosed in U.S. patent publication No. 2007/0216154, which is hereby incorporated by reference. Each vacuum device 12 and 14 includes a vacuum pad 42 and an attached vacuum pump 44 (FIG. 4-7). A housing 46 attaches to the vacuum pad 42 to enclose and secure the vacuum pump 44 to the vacuum pad 42. The housing 46 is shaped and sized to enclose the vacuum pump 44 while allowing for the attachment of an accessory, such as a connector 120.

The vacuum pad 42 is generally a conical frustum that defines a top face 48 having threaded holes 50 to mount with the housing 46 using fasteners 52. The vacuum pad 42 also includes a recessed vacuum face 54 being generally parallel to the top face 48, a sloped side surface 56 extending between the top face 48 and the vacuum face 54, and a generally circumferential seating edge 58 along the perimeter of the vacuum face 54. In this arrangement, the seating edge 58 can seat with the mounting surface 17 of a countertop or desk to form a vacuum cavity 60 (FIG. 10). The vacuum pad 42 defines a channel 62 extending from the top face 48 to the vacuum face 54 and sized to mate with the vacuum pump 44. Release tabs 64 extend outwardly from the side surface 56. The release tabs 64 are generally t-shaped ribs that are shaped and sized to enhance rigidity of the pad 42 and help prevent release of the vacuum device 16 from the mounting surface 17, such as during exposure to warmer temperatures.

Preferably, the pad 42 is made from a flexible material, such as, rubber, or plastic. However, the pad 42 can comprise any material that allows the vacuum pad 42 to seat with the mounting surface 26. Preferably, the material should not be prone to scuffing the mounting surface during installation or operation. In addition, the material can comprise any suitable color and may include other desirable attributes. For example, the pad 42 can be a reflective or glow-in-the-dark material so that it can be seen in dark environments.

The pump 44 includes a generally cylindrical plunger 66 and a hollow cylinder 68 that defines a chamber 70 sized and shaped to receive the plunger 66. The plunger 66 moves within the chamber 70 between a pressed position and a released position to create the vacuum cavity 60 between the vacuum face 54 and the mounting surface 17. The cylinder 68 has an opening to the chamber 70 at one end and is closed at the opposite end. A tube 72 extends generally perpendicularly from the closed end of the cylinder 68. The tube 72 is sized and shaped to insert into the channel 62 of the vacuum pad 42 to provide fluid communication between the cylinder chamber 70 and the vacuum cavity 60. The plunger 66 is sized to insert into the cylinder 68 with a sliding fit that allows the plunger 66 to move back and forth within the cylinder 68. A check valve 74 is positioned within the cylinder chamber 70 in communication with the chamber 70 and the tube 72 so that fluids and gases can only transfer into the tube 72 from outside of the cylinder 68. This allows the vacuum device 12 to be repumped without loss of remaining vacuum. In an alternate embodiment, an automatic pump can be used to increase the vacuum level of the vacuum device if it falls below a pre-determined level. In another alternate embodiment, a vacuum device includes a signaling component capable of indicating or sending a signal that indicates a loss of a designated amount of pressure, including, but not limited to, an audio signal, a visual signal, an electronic signal, or a wireless or Bluetooth® signal. For instance, a signaling component can send a wireless signal to a wireless phone and, in conjunction with appropriate software on the phone, indicate the vacuum pressure.

The plunger 66 is generally a rod with a push button 76 at one end, a seal 78 at the opposite end, and a biasing member 80 there between. The seal 78 is sized and shaped to seat against the inner wall of the cylinder 68. When the plunger 66 inserts into the cylinder chamber 70, the biasing member 80 biases the plunger 66 to the released position. The position of the plunger 66 in the released position will vary respective to the amount of vacuum pressure within the vacuum cavity 60.

An indicator 82 positioned about the lower portion of the push button 76 indicates to the operator the relative amount of vacuum pressure within the vacuum cavity 60. The indicator 82 is a colored ring or sleeve sized and shaped to attach around the lower portion of the push button 76. The indicator 82 can be red, yellow or any color that is easily seen. Additionally, the indicator 82 can be a reflective or glow-in-the-dark material so that it can be seen in dark atmospheres and under water. When no vacuum pressure exists in the vacuum cavity 60, the biasing member 80 extends the plunger 66 to its most extended release position. In this position, the indicator 82 is fully visible. As the pressure increases in the vacuum cavity 60, the force of the vacuum lessens the bias of the biasing member 80, and, in turn, the plunger 66 extends less from the chamber 70 and less of the indicator 82 is visible.

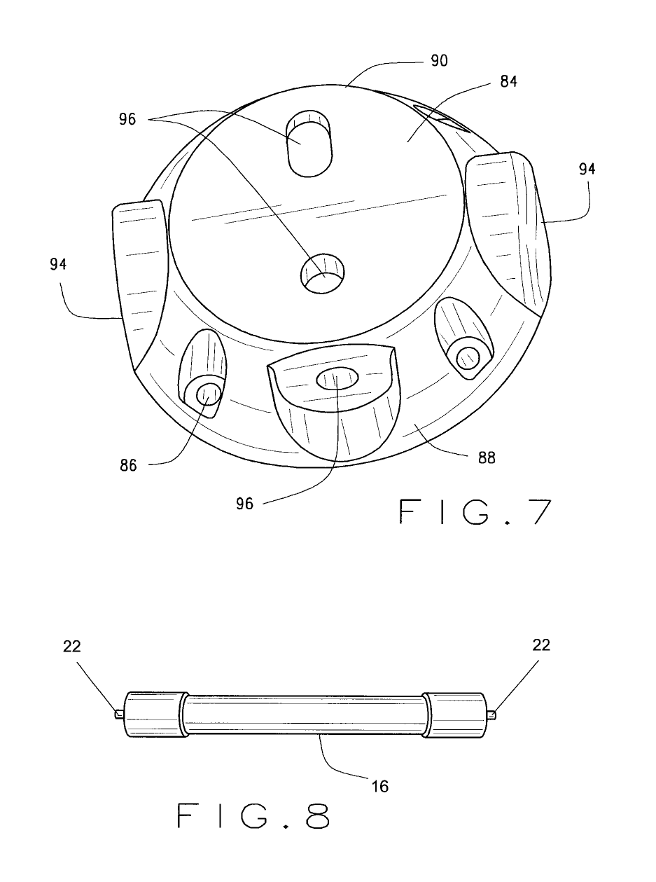

As shown in FIG. 7, the housing 46 is a generally cylindrical member with a generally cylindrical base which includes a top surface 84, bottom surface 86, first side 88, second side 90, third side 92, and pump side 94. The bottom surface 86 of the housing 46 defines housing apertures 96 for attachment to the vacuum pad 42 with fasteners. The top surface 84 defines attachment apertures 98 for attachment of accessories with appropriate means, such as fasteners, straps, and other suitable members. Although, housing apertures 96 and attachment apertures 98 are shown on top side 84 of housing 46, those skilled in the art will recognize that housing apertures 96 and attachment apertures 98 can be located on any side 88, 90, 92, 94 of the housing 46. Also, the housing apertures 96 and attachment apertures 98 can be holes, slots, or any other configuration sized and shaped to accommodate different dimensions of various manufacturers' accessories. The housing 46 can be made from a variety of materials, including marine grade stainless steel, powder-coated aluminum, rubber or plastic. For the vacuum mount system 10, it is preferable to use the ¼-20 threaded inserts, one in the horizontal position on top surface 84 and one on side surface 88.

In operation, an operator places the vacuum face 54 of pad 42 against a mounting surface 26, which creates a vacuum cavity 60 between the vacuum face 54 of the pad 42 and mounting surface 17 (FIG. 10). The operator repeatedly pushes the plunger 44 from the released position to the pressed position to remove fluid (air, gas, and/or water) from the vacuum cavity 60, thereby, reducing the pressure below the pressure the surrounding atmospheric pressure. This creates a vacuum such that edge 58 and vacuum face 54 of pad 42 seat against the mounting surface 26. A vacuum exists whenever the pressure within the space is less than the pressure that surrounds it. To obtain an adequate vacuum for operation, the operator should repeatedly press the plunger 66 until the indicator 82 is no longer visible when the plunger 66 is in the released position. If at any time during operation, the indicator 82 becomes visible indicating a loss of vacuum, the operator can again repeatedly push the plunger 66 until the indicator 82 is no longer visible.

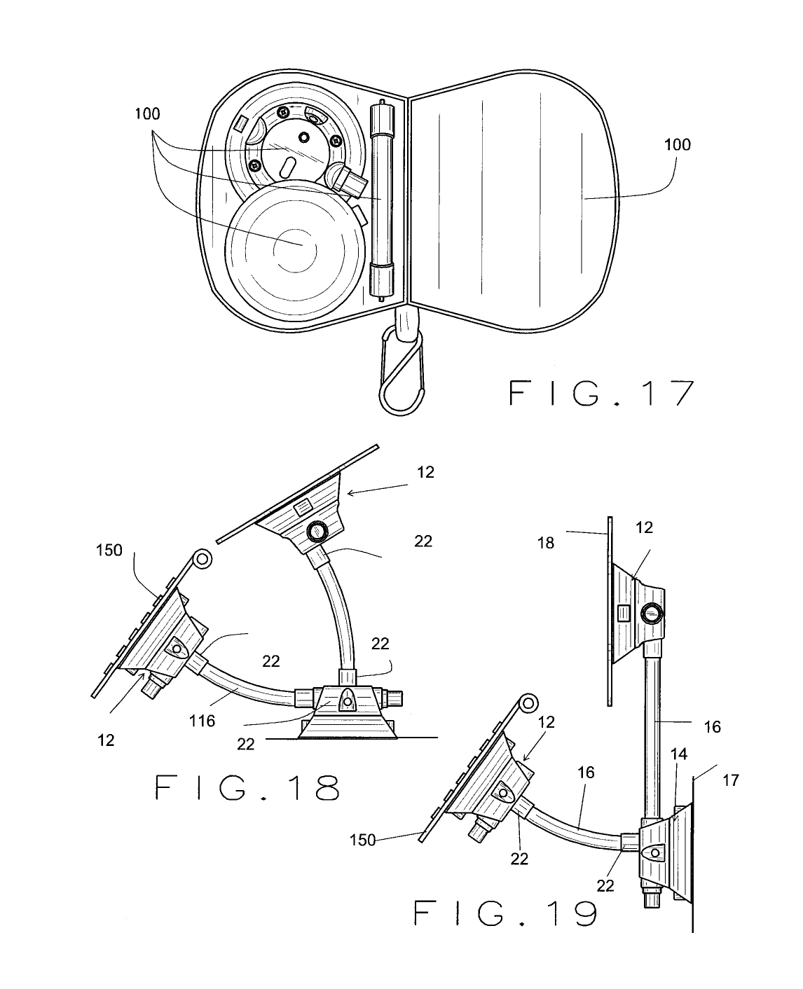

As shown in FIGS. 10-11, the two vacuum devices 12 and 14 are detachably connected via the connector 16 and secure respectively to the mounting surface 26 and to the rear surface of the PED 18. To release the vacuum and remove the mounting system 10, the operator lifts the release tabs 64 on the side face 56 of pad 42 away from the mounting surface 26. In other embodiments, a valve stem can be activated to release the vacuum device 12 and 14. Additionally, a twist button with a course thread located on the top face of the pad 42 can be used to release the vacuum device 12 and 14. The connector 16 can detach from the vacuum devices 12 and 14 for storage of the dissembled vacuum mount device 10 in a storage case 110 (see FIG. 17).

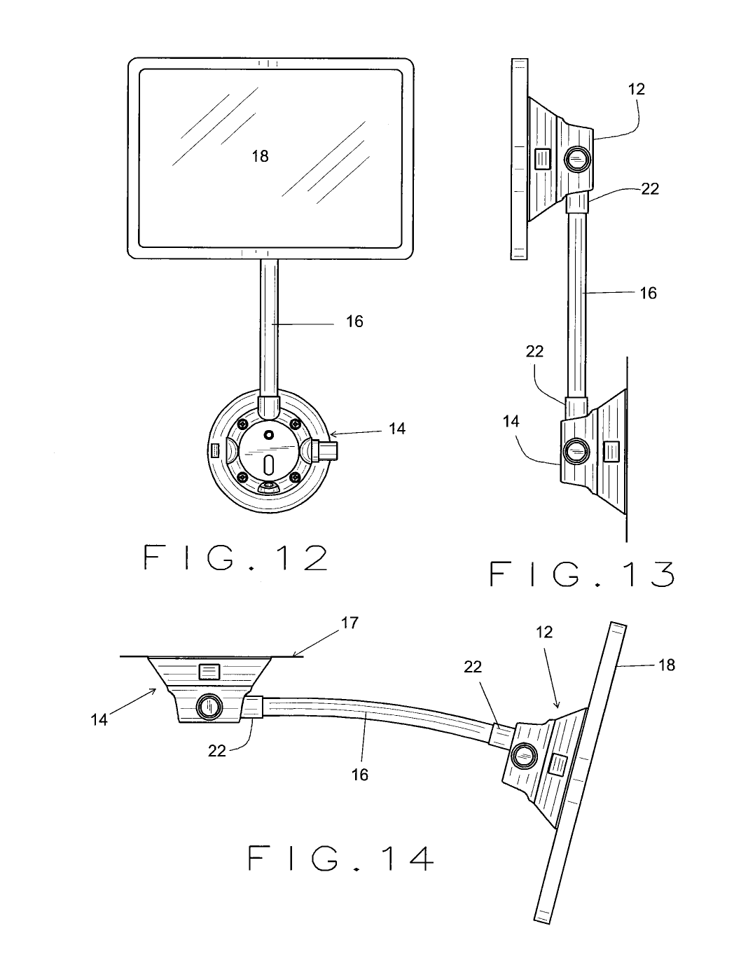

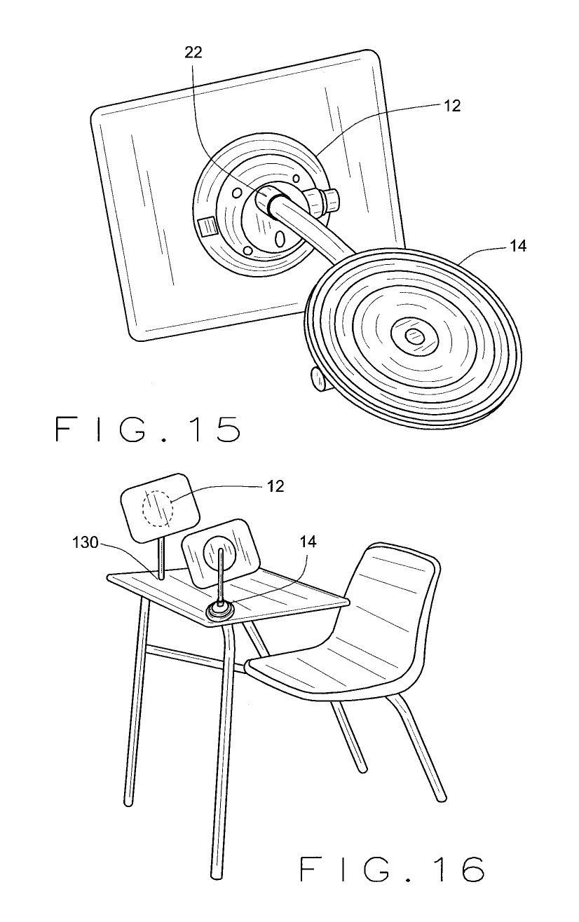

The connector 16 can attach to the vacuum devices 12 and 14 in multiple configurations to provide proper viewing angles of the PED according to user preferences and locations. For example, the connector 16 can either be placed in a generally vertical position (FIGS. 10-13) or a generally horizontal position (FIGS. 14-15). In this way, the vacuum mount system 10 provides multiple mounting positions. As shown in a second alternate embodiment of FIG. 11, a PED 18 mounts in a generally vertical position from a generally horizontal mounting surface 17, such as a desktop. Alternatively, the connector 16 can attach to the vacuum device 12 so that the PED 18 is in a generally horizontal or angled position as seen in FIG. 18 to allow a user to look down at the PED 18.

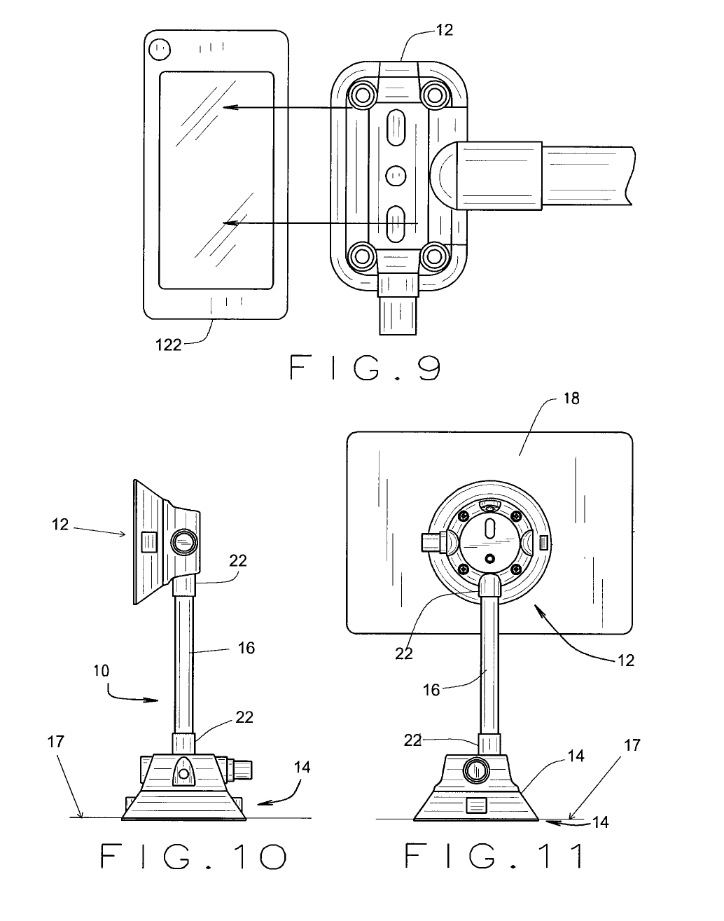

While the vacuum device 12 and 14 of FIGS. 3-8 are generally circular, other sizes and shapes can be used to accommodate any size PED. For example, FIG. 9 is a first alternate embodiment of the vacuum mount system 10, which includes a generally rectangular shaped vacuum device 120 sized and shaped to generally correspond with a mobile phone 122, such as an iPhone®.

FIGS. 12 and 13 show a third alternate embodiment with a generally vertical mounting position for use in areas of compact space, such as mounting to the seat tray on an airplane. In this position, the connector 16 mounts to the vacuum device 12 in a generally vertical position and to the vacuum device 14 in a generally vertical position. In this configuration, the mount system 10 along with the PED 18 maintains a very low profile and can hug the vertical wall it is mounted to. An airplane seat has the problem of creating a cramped space for the user and with this mounting position the PED 18 can hug the seat back very closely.

Another common but difficult position to mount is on the windshield of a car. Windshields have an angle somewhere between vertical and horizontal and connectors mounted from a windshield typically will have to come from center of mount and down and then travel back up which severely limits the load the connector can take as it will want to drop or droop and not stay in position. FIGS. 14 and 15 show a fourth alternate embodiment with the vacuum device 14 mounted to the windshield in an angled position and the connector 16 in a generally vertical position. This arrangement provides a more linear path for the connector 16, and thus increased support of the PED 18 because the connector 16 extends further out and up. If the connector 16 were positioned in the generally horizontal position on the vacuum device 14 the PED 18 would not reliably stay in position and would drop towards a lower position. The connector 16 is also mounted to the vacuum device 12 in the horizontal housing position.

FIG. 16 is a fifth alternate embodiment of the vacuum mount system 10 with the vacuum device 14 removed and the connector 16 attached to a permanent mount 130, such as with a female ¼-20 within a mounting surface. Some locations like a school desk do not have enough space to attach the vacuum device 14. In addition, a permanently attached vacuum mount system 10 can prevent theft or removal from the desk or other mounting surface. The connector 16 attaches at one end to the PED 18 with the first vacuum device 12 and at the other end to the permanent mount 130, such as with an adhesive or fastener.

FIGS. 18 and 19 are a sixth and seventh embodiment of the vacuum mount system having a keyboard attached with a second connector 116 and vacuum device 14. FIG. 18 shows the keyboard 150 attached to the vacuum device 14 in a generally vertical position. The vacuum device 12 is mounted underneath the keyboard 325. FIG. 19 shows the keyboard 150 attached to the vacuum device 14 in a generally horizontal housing position. Those skilled in the art will recognize that other arrangements can also be used.

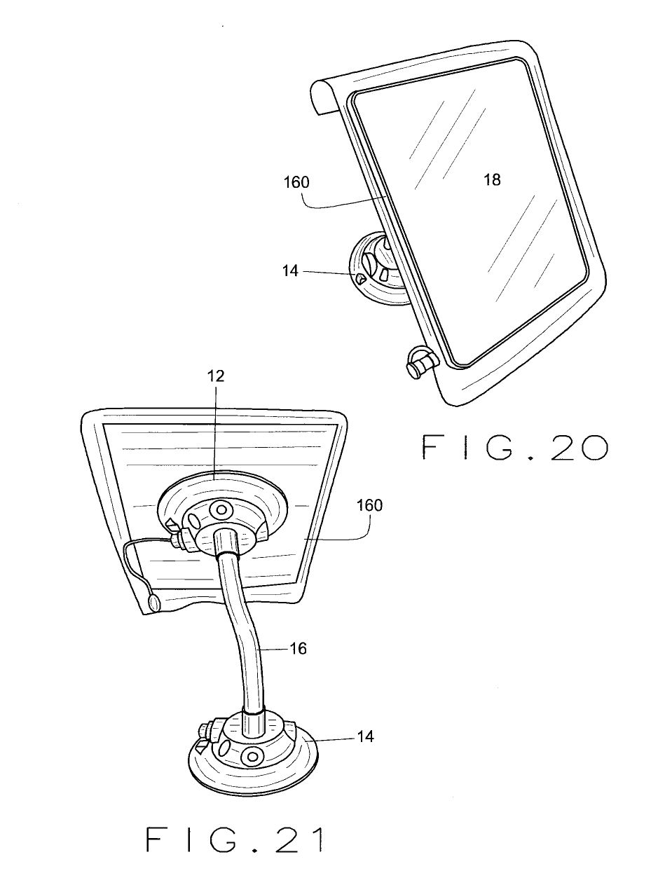

FIGS. 20 and 21 is an eighth embodiment of the vacuum mount system 10. In some situations, the PED 18 must be protected from various elements, such as water. The PED 18 can be enclosed by a waterproof case 160 before attachment by the vacuum mount system 10. The vacuum device 12 attaches directly to the back of the waterproof case 160. In this way, the PED 18 detaches for use elsewhere, as opposed to prior art design where waterproof mounts are bulky and difficult to install and take apart. A flat surface aids attachment of the vacuum device 12. Therefore, a waterproof case 160 should provide a hard smooth exterior and eliminate any air inside the case 160.

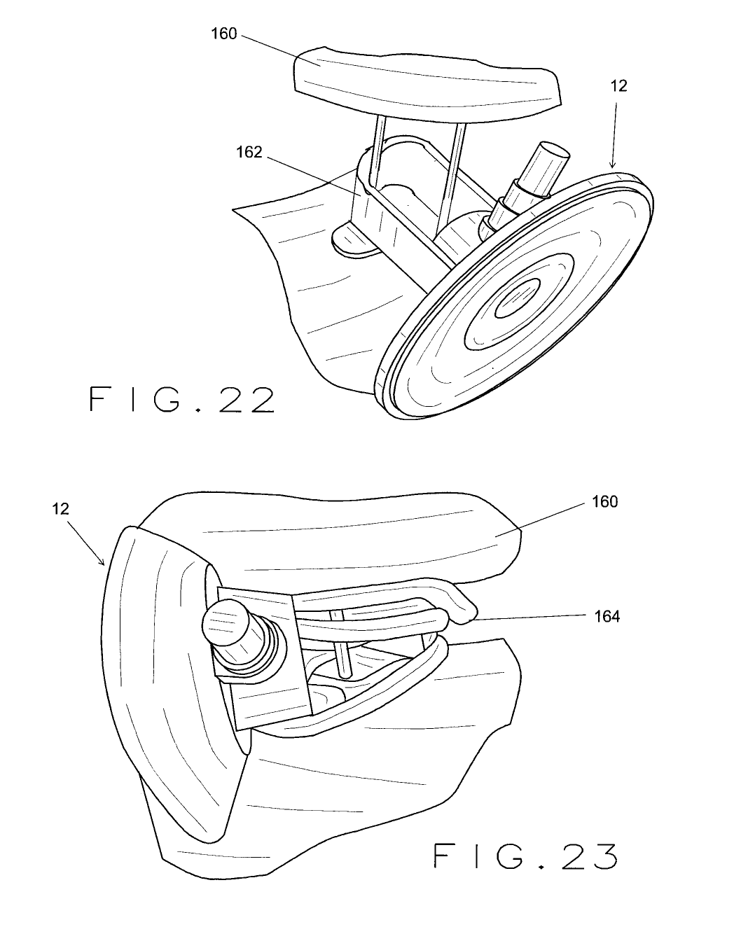

FIG. 22 is a ninth alternate embodiment of the vacuum mount system 10 having a vacuum device 12 removably attached to a vehicle headrest 160 with a strap 162, such as with a hook and loop device on each end of the strap 162.

FIG. 23 is a tenth alternate embodiment of the vacuum mount system 10 having a vacuum device 12 removably attached to a vehicle headrest 160 with a flexible connector 164.

Changes can be made in the above constructions without departing from the scope of the disclosure, it is intended that all matter contained in the above description or shown in the accompanying drawings shall be interpreted as illustrative and not in a limiting sense.

1. A vacuum mount system, comprising:
a first vacuum device having a pad shaped and sized to detachably seat an electronic device to form a vacuum cavity, a plunger attached to the pad and in fluid communication with the vacuum cavity, and an indicator positioned on the plunger to indicate the level of vacuum pressure within the vacuum cavity;
a second vacuum device having a pad shaped and sized to detachably seat with a mounting surface to form a vacuum cavity, a plunger attached to the pad and in fluid communication with the vacuum cavity, and an indicator positioned on the plunger to indicate the level of vacuum pressure within the vacuum cavity; and
a connector detachably connected between the first vacuum device and the second vacuum device.

2. The vacuum mount system of claim 1, further comprising:
a third vacuum device having a pad shaped and sized to detachably seat an electronic device to form a vacuum cavity, a plunger attached to the pad and in fluid communication with the vacuum cavity, and an indicator positioned on the plunger to indicate the level of vacuum pressure within the vacuum cavity; and
a second connector detachably connected between the third vacuum device and the first vacuum device.

3. The vacuum mount system of claim 1, wherein the first vacuum device is configured for mounting in a generally horizontal, a generally vertical, or angled position.

4. The vacuum mount system of claim 1, wherein the second vacuum device is configured for mounting in a generally horizontal, a generally vertical, or angled position.

5. The vacuum mount system of claim 1, further comprising a waterproof case shaped and sized to receive the portable electronic device.

6. The vacuum mount system of claim 1, further comprising a case sized and shaped to receive the first vacuum device, the second vacuum device, and the connector when disassembled.

7. The vacuum mount system of claim 1, wherein the first vacuum device is shaped and sized to generally correspond to the shape and size of the portable electronic device.

8. The vacuum mount system of claim 1, further comprising a magnetic fastener configured to connect between the first vacuum device and the connector.

9. A vacuum mount system, comprising;
a first vacuum device configured for detachable connection to a portable electronic device;
a second vacuum device configured for detachable connection to a mounting surface;
a flexible connector attached between the first vacuum device and the second vacuum device.

10. The vacuum mount system of claim 9, wherein the first vacuum comprises:
a pad shaped and sized to detachably seat an electronic device to form a vacuum cavity, a plunger attached to the pad and in fluid communication with the vacuum cavity, and an indicator positioned on the plunger to indicate the level of vacuum pressure within the vacuum cavity.

11. The vacuum mount system of claim 9, further comprising:
a third vacuum device for detachable connection to a portable electronic device; and
a second connector detachably connected between the third vacuum device and the first vacuum device.

12. The vacuum mount system of claim 9, wherein the first vacuum device is configured for mounting in a generally horizontal, a generally vertical, or angled position.

13. The vacuum mount system of claim 9, wherein the second vacuum device is configured for mounting in a generally horizontal, a generally vertical, or angled position.

14. The vacuum mount system of claim 9, further comprising a waterproof case shaped and sized to receive the portable electronic device.

15. The vacuum mount system of claim 9, further comprising a case sized and shaped to receive the first vacuum device, the second vacuum device, and the connector when disassembled.

16. The vacuum mount system of claim 9, wherein the first vacuum device is shaped and sized to generally correspond to the shape and size of the portable electronic device.

17. The vacuum mount system of claim 9, further comprising a magnetic fastener configured to connect between the first vacuum device and the connector.

18. A vacuum mount system, comprising:
a first vacuum device having a pad shaped and sized to detachably seat an electronic device to form a vacuum cavity, a plunger attached to the pad and in fluid communication with the vacuum cavity, and an indicator positioned on the plunger to indicate the level of vacuum pressure within the vacuum cavity; and
a flexible connector configured for attachment to a vehicle headrest.
